(19) United States
(12) Patent Application Publication
(10) Pub. No.: US 2013/0346562 A1
(43) Pub. Date: Dec. 26, 2013

(54) DATA TRANSMISSION METHOD AND APPARATUS FOR MOBILE TERMINAL

(71) Applicant: SAMSUNG ELECTRONICS CO., LTD., Suwon-si (KR)

(72) Inventor: Jinyup KIM, Yongin-si (KR)

(73) Assignee: Samsung Electronics Co., Ltd., Suwon-si (KR)

(21) Appl. No.: 13/891,602

(22) Filed: May 10, 2013

(30) Foreign Application Priority Data
Jun. 20, 2012 (KR) 10-2012-0066392

(51) Int. Cl. H04L 29/06

(52) U.S. Cl. CPC H04L 65/608
USPC 709/219

(57) ABSTRACT

A data transmission method and apparatus for a mobile terminal are provided. The method enables the mobile terminal to share screen data with an external device through Wi-Fi Direct. The method includes establishing an RTP session using a first transport protocol by sending an RTSP setup message to the external device, and transmitting screen data as RTP packets to the external device through the first transport protocol, monitoring RTP packets to determine whether to conduct RTP transport switching to the external device, sending, upon determining to conduct RTP transport switching, an RTSP request message for RTP transport switching to the external device, and transmitting screen data as RTP packets to the external device through a second transport protocol. The external device may also request and conduct RTP transport switching using a desired transport protocol through RTSP.

### PRIORITY

This application claims the benefit under 35 U.S.C. §119(a) of a Korean patent application filed on Jun. 20, 2012 in the Korean Intellectual Property Office and assigned Serial No. 10-2012-0066392, the entire disclosure of which is hereby incorporated by reference.

### BACKGROUND OF THE INVENTION

1. Field of the Invention

The present invention relates to a method and apparatus for transmitting data from a mobile terminal to an external device. More particularly, the present invention relates to a data transmission method and apparatus for a mobile terminal that enables display data of the mobile terminal to be presented on an external device.

2. Description of the Related Art

A mobile terminal may download data from the Internet or the like through various communication schemes and may transmit downloaded or stored data to an external device. When the external device includes a display unit, screen data of the mobile terminal may be displayed on the display unit of the external device.

The mobile terminal may send data to the external device through Wi-Fi Direct communication. Wi-Fi Direct enables direct communication between Wi-Fi devices without use of an IP network. Wi-Fi Direct enabled devices may communicate with each other and share information without a hotspot, router, or access point.

When a mobile terminal is connected with an external device through Wi-Fi Direct communication, screen data displayed on the mobile terminal may also be displayed on the external device by means of Wi-Fi Display or Miracast (a standard for screencasting). In this case, Real Time Streaming Protocol (RTSP) is used to create, maintain and end an end-to-end session between the mobile terminal and external device; Real-time Transport Protocol (RTP) is used to transmit screen data of the mobile terminal to the external device; and the external device displays received screen data. As a result, the mobile terminal and external device may display the same information.

However, existing Wi-Fi Display communication does not support adaptive transport switching according to changes in states or communication conditions of the mobile terminal while the mobile terminal is streaming display data to the external device. For example, when a call handling application is activated while a mobile terminal is streaming moving images to an external device for screencasting, the mobile terminal may be unable to perform a switching operation needed to adaptively transmit display data produced by the call handling application. In addition, while Wi-Fi Display based on a Wi-Fi Direct connection can support high picture quality and ease of connectivity, it may be highly vulnerable to Wi-Fi noise. Accordingly, existing Wi-Fi Display communication may fail to adaptively transmit screen display data when a communication condition changes while high-definition display data is streamed.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above problems and/or disadvantages and to provide at least the advantages described below. Accordingly, an aspect of the present invention is to provide a method and apparatus for a mobile terminal that enable the mobile terminal to share screen data with an external device through a Wi-Fi Direct connection under optimum conditions by performing adaptive transport switching according to states of a Wi-Fi Direct domain.

Another aspect of the present invention is to provide a method and apparatus for a mobile terminal that, when a state change occurs in the mobile terminal sharing screen data with an external device, enable the mobile terminal to perform transport protocol switching so that a transport protocol fitting well with the state change is used to transmit screen data.

Another aspect of the present invention is to provide a method and apparatus for a mobile terminal wherein, when the mobile terminal shares screen data with an external device, communication conditions such as traffic, bandwidth, congestion and Transmission Control Protocol (TCP)/Internet Protocol (IP) capabilities are analyzed and User Datagram Protocol (UDP), TCP or Scalable TCP (SCTP) is used to adaptively transmit screen data according to analysis results, thereby providing a screencasting feature resistant to Wi-Fi noise and meeting user expectations.

In accordance with an exemplary embodiment of the present invention, a method of enabling a mobile terminal to share screen data with an external device through Wi-Fi Direct is provided. The method includes establishing an Real-time Transport Protocol (RTP) session using a first transport protocol by sending an Real Time Streaming Protocol (RTSP) setup message to the external device, and transmitting screen data of a first application as RTP packets to the external device through the first transport protocol, sending, when a second application is activated, an RTSP request message for RTP transport switching to the external device, and transmitting screen data of the second application as RTP packets to the external device through a second transport protocol, and sending, when execution of the second application is ended, an RTSP request message for RTP transport switching to the external device, and transmitting screen data of the first application to the external device through the first transport protocol.

In accordance with another exemplary embodiment of the present invention, a method of enabling a mobile terminal to share screen data with an external device through Wi-Fi Direct is provided. The method includes establishing an RTP session using a first transport protocol by sending an RTSP setup message to the external device, and transmitting screen data to the external device as RTP packets through the first transport protocol, monitoring RTP packets to determine whether to conduct RTP transport switching, sending, upon determining to conduct RTP transport switching, an RTSP request message for RTP transport switching to the external device, and transmitting screen data as RTP packets to the external device through a second transport protocol.

In accordance with another exemplary embodiment of the present invention, a mobile terminal supporting screen sharing with an external device is provided. The mobile terminal includes a communication unit for transmitting screen data to the external device through Wi-Fi Direct, a control unit for establishing an RTP session using a first transport protocol by sending an RTSP setup message to the external device, for transmitting screen data to the external device as RTP packets through the first transport protocol, for sending, when RTP transport switching is needed, an RTSP request message for RTP transport switching to the external device, and for conducting transport protocol switching to a second transport protocol, and a display unit for displaying screen data under control of the control unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description in conjunction with the accompanying drawings, in which:

FIG. 1 illustrates a data streaming architecture including a server, a mobile terminal, and an external device according to an exemplary embodiment of the present invention;

FIG. 2 is a block diagram of a mobile terminal according to an exemplary embodiment of the present invention;

FIG. 3 illustrates transport protocol switching performed by a mobile terminal for adaptive stream transmission with respect to usage conditions and/or communication conditions according to an exemplary embodiment of the present invention;

FIG. 4 illustrates a Wi-Fi Display configuration in a mobile terminal according to an exemplary embodiment of the present invention;

FIG. 5 is a sequence diagram illustrating transport protocol switching while a mobile terminal shares screen data with an external device through Wi-Fi Display, where different transport protocols are utilized according to usage condition changes, according to an exemplary embodiment of the present invention;

FIG. 6 is a flowchart of a procedure performed by a mobile terminal for transport protocol switching according to an exemplary embodiment of the present invention;

FIG. 7 is a sequence diagram illustrating transport protocol switching while a mobile terminal shares screen data with an external device through Wi-Fi Display, where the mobile terminal and/or the external device perform switching between multiple transport protocols according to analysis of communication conditions in the Wi-Fi Direct domain, according to an exemplary embodiment of the present invention;

FIG. 8 is a flowchart of a procedure for Real-time Transport Protocol (RTP) switching while a mobile terminal sends a screencast to the external device through Wi-Fi Display according to an exemplary embodiment of the present invention;

FIG. 9 is a flowchart of a procedure performed by a mobile terminal for RTP switching while the mobile terminal sends a screencast to the external device through Wi-Fi Display according to an exemplary embodiment of the present invention; and

FIG. 10 is a flowchart of a procedure performed by an external device for RTP switching while a mobile terminal sends a screencast to the external device through Wi-Fi Display according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to an exemplary embodiment of the present invention, a mobile terminal sends screen data being displayed to an external device having a large display unit, and the external device displays received screen data on the large display unit. A screen display of the mobile terminal is synchronized with screen display of the external device. The mobile terminal may include a Wi-Fi station (Wi-Fi STA) domain (referred to as a first domain) to receive HTTP-based streaming such as YouTube, and a Wi-Fi Direct domain (referred to as a second domain) to send the received streaming data as H.264-based streaming to an external device. The mobile terminal may adaptively transmit streams by performing Real-time Transport Protocol (RTP) switching according to usage conditions and/or communication conditions in the Wi-Fi Direct domain (second domain).

A mobile terminal according to an exemplary embodiment of the present invention adaptively sends streams through RTP switching according to a usage condition change. While the mobile terminal sends streams to an external device by means of Wi-Fi Display based on a Wi-Fi Direct connection, when a usage condition changes (for example, change of screen display due to application execution), the mobile terminal sends streams through a transport protocol newly selected in consideration of usage condition change.

The mobile terminal may provide optimal services to the user by applying adaptive transport switching in consideration of communication conditions related to traffic, bandwidth and congestion in the Wi-Fi Direct domain (second domain for communication with an external device).

As used in this description, “usage conditions” are related with applications executed in the mobile terminal. For example, a usage condition change may refer to a change in screen display mode occurring when the currently active application changes from a first application (e.g. video player) to a second application (e.g. call handling program). Additionally, “communication conditions” are related with the Wi-Fi Direct domain in-between the mobile terminal and an external device and may include conditions related with traffic, bandwidth, congestion and end-node characteristics.

The term “screen sharing” or “screencasting” refers to a state in which the mobile terminal and external device display the same screen data. According to an exemplary embodiment of the present invention, screen sharing may be realized using Wi-Fi Direct communication. In the following description, “Wi-Fi Display” and “Miracast” may be used interchangeably.

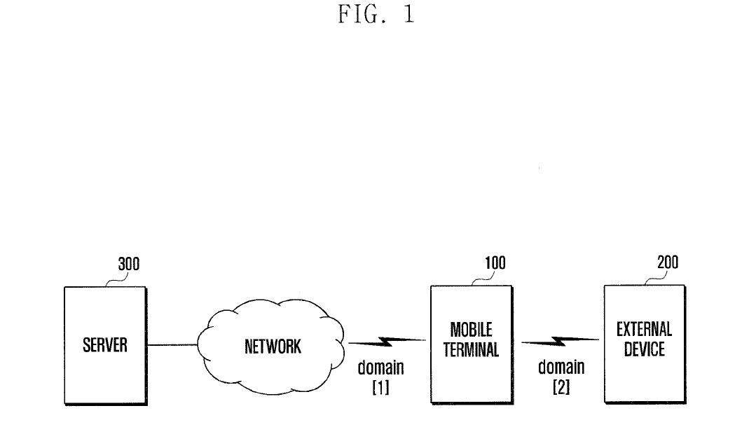

FIG. 1 illustrates a data streaming architecture including a server, a mobile terminal and an external device according to an exemplary embodiment of the present invention.

Referring to FIG. 1, the mobile terminal 100 may include a Wi-Fi STA domain (first domain) to receive HTTP-based streaming from the server 300, and a Wi-Fi Direct domain (second domain) to send the received streaming data as H.264-based streaming to the external device 200. As described above, the present invention relates to providing optimal services to the user by applying adaptive transport switching in consideration of communication conditions related to traffic, bandwidth, congestion and end-node characteristics in the Wi-Fi Direct domain for communication with the external device 200.

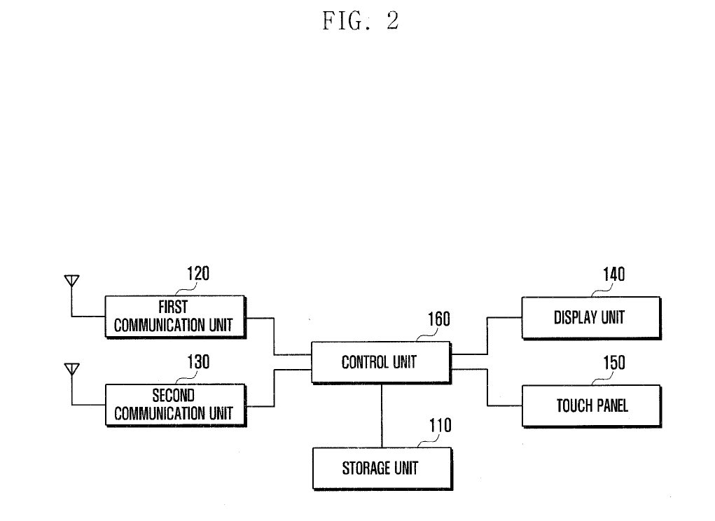

FIG. 2 is a block diagram of a mobile terminal according to an exemplary embodiment of the present invention.

Referring to FIG. 2, the mobile terminal 100 may be one of various digital devices such as a smartphone, mobile communication terminal, tablet computer and laptop computer.

In FIG. 2, a first communication unit 120 performs radio communication with a base station. The first communication unit 120 may be based on Long Term Evolution (LTE), Wideband Code Division Multiple Access (WCDMA) or Global System for Mobile Communications (GSM) technology. A second communication unit 130 performs wireless communication to connect to the Internet or an external device. The second communication unit 130 may be based on Wi-Fi or WiBro technology. In the following description, the first communication unit 120 is assumed to be an LTE communication module, and the second communication unit 130 is assumed to be a Wi-Fi communication module.

A control unit 160 controls the overall operation of the mobile terminal. The control unit 160 controls an operation to transmit streams in an optimal way by performing transport protocol switching according to usage conditions and/or communication conditions in the Wi-Fi Direct domain for communication with the external device. While the mobile terminal sends streams to the external device by means of Wi-Fi Display based on a Wi-Fi Direct connection, when a usage condition changes (e.g., a change of screen display due to application execution), the mobile terminal sends streams through a transport protocol newly selected in consideration of the usage condition change. The control unit 160 applies adaptive transport switching in the Wi-Fi Direct domain for communication with the external device in consideration of communication conditions related to traffic, bandwidth, congestion and end-node characteristics.

A storage unit 110 may include a program section to store programs operating the mobile terminal and programs realizing functions of the present invention, and a data section to store tables needed to operate the mobile terminal and data generated during program execution.

A display unit 140 displays information of an executed application under control of the control unit 160. The display unit 140 may be realized using Liquid Crystal Display (LCD) or Organic Light Emitting Diode (OLED) technology. A touch panel 150 may be realized using resistive, capacitive and/or electromagnetic induction technology. The touch panel 150 detects user touch with a finger or stylus and sends a corresponding touch signal to the control unit 160. For example, when the touch panel 150 is a capacitive panel, the touch panel 150 may detect a finger touch; and when the touch panel 150 is an electromagnetic induction panel, the touch panel 150 may detect a pen touch. The display unit 140 and the touch panel 150 may be combined to form a touchscreen.

The mobile terminal 100 may connect to the Internet and download data through the first communication unit 120 or the second communication unit 130, and communicate with the external device 200 through the second communication unit 130 using Wi-Fi Direct communication. The mobile terminal may communicate with the external device 200 through the second communication unit 130 using a Wi-Fi Direct connection, realizing a Wi-Fi Display feature (screencasting).

The control unit 160 decodes data downloaded from a server on the Internet and encodes the data in a format suitable for Wi-Fi Display. For moving images, downloaded data is Motion Picture Experts Group (MPEG) data and data to be sent to the external device is H.264 data. For the external device to play back moving images downloaded from the Internet using the external device, the control unit 160 decodes downloaded MPEG data, buffers the decoded data, encodes the buffered data according to H.264, and sends the encoded data to the external device.

According to an exemplary embodiment of the present invention, when the mobile terminal 100 streams data to the external device, the control unit 160 may send screen data of a moving image player application through TCP and send screen data of another application through UDP. According to another exemplary embodiment of the present invention, while a moving image player application is being executed, when a different application is activated, the control unit 160 executes the newly activated application in the foreground by displaying screen data thereof on the display unit 140 and sending the screen data to the external device through the User Datagram Protocol(UDP), and processes the moving image player application in the background. The moving image player application may display moving images downloaded from an external network, display moving images stored in the storage unit 110, or display moving images captured by a camera module.

While the mobile terminal sends a screencast to the external device, the control unit 160 monitors RTP streams and may perform transport protocol switching between Transmission Control Protocol (TCP) and UDP according to monitoring results. RTP streams may be monitored in consideration of parameters related to traffic, bandwidth, congestion and TCP/Internet Protocol (IP) capacity.

When screen data is streamed to the external device 200 using TCP as a transport protocol, the control unit 160 may control an operation not to display the screen data on the display unit 140. In the event that TCP is used as the transport protocol, the external device periodically reports a reception status to the mobile terminal through RTP Control Protocol (RTCP) and requests retransmission upon occurrence of a transmission error. Accordingly, when TCP is used as the transport protocol, screen display of the mobile terminal may not be identical to screen display of the external device. For this reason, according to an exemplary embodiment of the present invention, when TCP is used as a transport protocol, the control unit 160 does not display screen data on the display unit 140. In this case, the control unit 160 may control the display unit 140 to display screen data that is different from screen data being streamed to the external device.

In the event that UDP is used as a transport protocol, the control unit 160 may control the display unit 140 to display screen data, which is streamed to the external device. As the purpose of streaming screen data from the mobile terminal to the external device is to display the screen data on the external device, the control unit 160 may control an operation not to display the screen data on the display unit 140 regardless of the transport protocol employed.

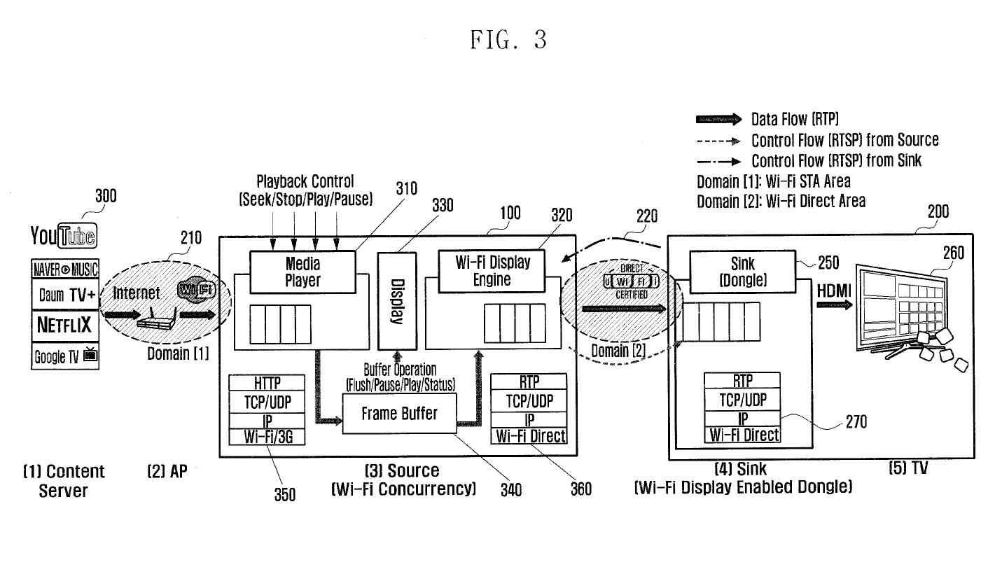

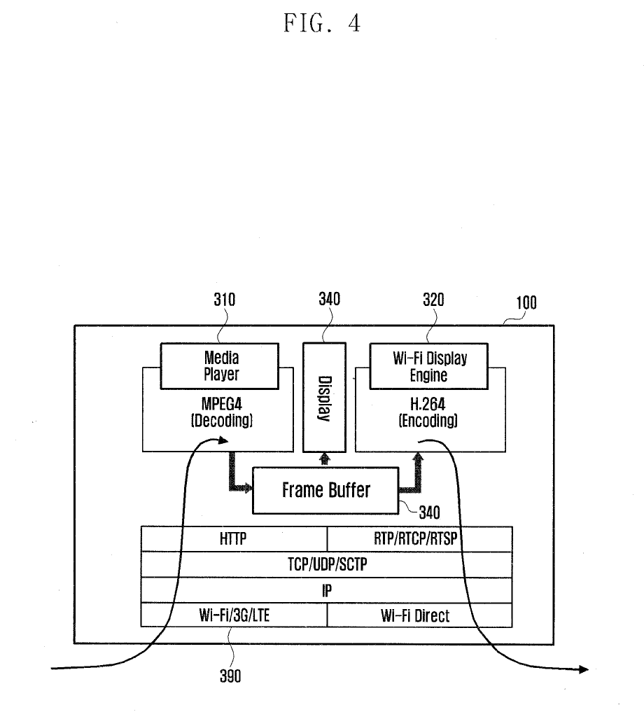

FIG. 3 illustrates transport protocol switching performed by a mobile terminal for adaptive stream transmission according to usage conditions and/or communication conditions according to an exemplary embodiment of the present invention. FIG. 4 illustrates a Wi-Fi Display configuration in a mobile terminal according to an exemplary embodiment of the present invention.

Referring to FIGS. 3 and 4, the mobile terminal 100 may download HTTP-based streams from the server 300 through a first domain 210. In the first domain 210, the first communication unit 120 or the second communication unit 130 may be used to download streams. The server 300 may be a server having video and/or audio, such as YouTube, NAVER, Daum TV, Netflix, or Google TV. A media player 310 executed by the mobile terminal 100 stores downloaded streams in a frame buffer 340, and may display streams stored in the frame buffer 340 on a display 330 in response to a playback control command entered through an input means such as a touch panel. A protocol stack 350 is used for reception in the first domain 210. The frame buffer 340 may temporarily store downloaded streams, which are then transmitted through a second domain 220 to the external device 200. The downloaded streams may also be stored in the storage unit 110 (not shown).

A Wi-Fi Display engine 320 converts the format of data (such as moving images) stored in the storage unit 110 (not shown) or streaming data temporarily stored in the frame buffer 340 into a Wi-Fi Display format. Reference numeral 360 indicates a protocol stack used for transmission in the second domain 220. Data in the Wi-Fi Display format is sent through the protocol stack 360 to the external device 200. A protocol stack 270 is used by the external device 200 to receive data from the mobile terminal 100. In FIG. 3, the external device 200 is composed of a TV 260 and a dongle 250. When the TV 260 is a Wi-Fi Direct enabled device, the dongle 250 may be unnecessary. When the TV 260 is not a Wi-Fi Direct enabled device, the TV 260 can be connected with the dongle 250 through an HDMI cable. In the following description, the external device 200 is assumed to be composed of the dongle 250 and the TV 260.

According to an exemplary embodiment of the present invention, switching between transport protocols is performed using Real Time Streaming Protocol (RTSP) according to various conditions at the second domain 220 between the mobile terminal 100 and the dongle 250. As shown in FIG. 3, in the first domain 210, an HTTP-based stream is received from an access point (AP); and in the second domain 220, streaming data from the first domain 210 (MPEG-4 stream) is decoded, the decoded data is re-encoded in H.264 format, and the H.264 data is sent to the dongle 250. In the second domain 220, the mobile terminal 100 acting as a source encodes screen data and sends the encoded screen data; and the external device 200 (here, dongle 250) acting as a sink receives screen data from the mobile terminal 100 (i.e. the source), decodes the received screen data, and displays the decoded screen data on the TV 260.

FIG. 4 illustrates a Wi-Fi Display configuration in a mobile terminal according to an exemplary embodiment of the present invention.

In FIG. 4, TCP, UDP and SCTP are transport layer protocols. UDP is used in most cases. TCP, SCTP, or Reliable UDP may also be used in consideration of latency and packet loss. Selection of a transport layer protocol is notified by RTSP to the external device 200 (or to the mobile terminal 100). Selection of a transport layer protocol may be determined by at least one of the mobile terminal 100 and the external device 200 according to usage conditions and/or communication conditions (such as traffic, bandwidth, congestion and TCP/IP capacity). For example, when RTT of TCP or Ping indicates congestion, transport protocol switching may be determined.

RTP, RTCP, and RTSP form a set of streaming protocols. RTP is used to transmit audio/video packets. RTCP is used to periodically report RTP packet transmission and reception status between the sender (source) and receiver (sink). RTSP is used to maintain a session between the source and the sink and is normally based on TCP. RTSP is used for session setup and transport protocol switching.

Transport layer protocols including TCP, UDP, and SCTP operate on the basis of IP. Streams may be downloaded through Wi-Fi STA/3G/LTE communication in the first domain 210. Streams may also be sent through Wi-Fi Direct communication in the second domain 220.

As described above, in the second domain 220, Wi-Fi Display based on a Wi-Fi Direct connection is used to stream screen data to the external device 200. While Wi-Fi Display can support high picture quality and ease of connectivity, it is vulnerable to Wi-Fi noise. According to exemplary embodiments of the present invention, RTP packets are adaptively transported through UDP, TCP or SCTP according to conditions related to traffic, bandwidth, congestion and TCP/IP capabilities. For example, for viewing of high-definition moving images, TCP may be used to transport RTP packets because picture quality is more important than latency. For game playing, UDP, Reliable UDP or SCTP may be used because low latency is most important.

According to exemplary embodiments of the present invention, when communication conditions are not good or an application requiring low latency is executed, User Datagram Protocol (UDP) may be used. This is because UDP supports connectionless services without sessions between hosts, does not guarantee acknowledgment or packet delivery order, is fast and efficient, and supports point-to-point and point-to-multipoint communication.

When communication conditions are acceptable or an application not requiring low latency is executed, Transmission Control Protocol (TCP) may be used. This is because TCP supports connection-oriented services with sessions between hosts and guarantees acknowledgments and packet delivery order for reliable data transmission. Compared with UDP, TCP is slow and has high overhead.

When the mobile terminal 100 is connected with the dongle 250 through Wi-Fi Display, RTSP is used to create, maintain and terminate an end-to-end session. The mobile terminal 100 streams RTP packets containing screen data through UDP, TCP, or SCTP to the dongle 250, which then outputs the screen data to the TV 260. The session between the mobile terminal 100 and the external device 200 is created and maintained using RTSP. RTP data is delivered through a transport protocol such as UDP, TCP or SCTP. Transport protocols such as UDP, TCP and SCTP may have different impacts on RTP transmission (in terms of latency, error recovery and buffering time) according to changes in usage conditions and/or communication conditions.

According to an exemplary embodiment of the present invention, while the mobile terminal shares screen data with the external device by means of Wi-Fi Display, when usage conditions change, the mobile terminal streams screen data through a transport protocol newly selected in consideration of the usage condition change. According to another embodiment of the present invention, when the mobile terminal shares screen data with the external device, the mobile terminal and/or the external device monitor communication conditions in the Wi-Fi Direct domain and perform transport protocol switching according to monitoring results. The mobile terminal and/or the external device may use RTSP to switch between transport protocols carrying RTP data in consideration of parameters related to traffic, bandwidth, congestion (RTT, retransmission and windowing), and end-node characteristics such as TCP/IP capacity.

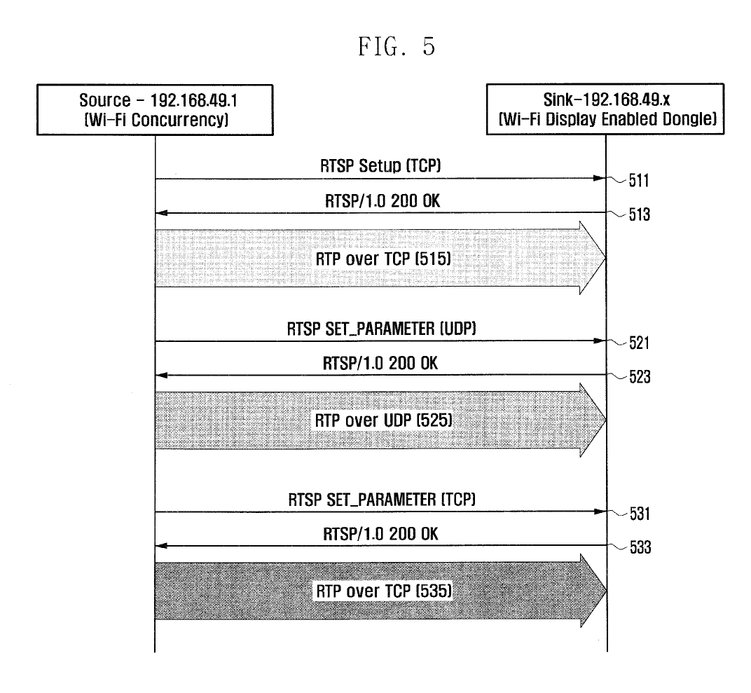

FIG. 5 is a sequence diagram illustrating transport protocol switching while a mobile terminal shares screen data with an external device through Wi-Fi Display, where different transport protocols are utilized according to usage condition changes, according to an exemplary embodiment of the present invention. In the following description with respect to FIG. 5, it is assumed that a video player application uses TCP and another application uses UDP.

Referring to FIG. 5, to transmit video streams to the external device 200 through Wi-Fi Display, the mobile terminal 100 sends an RTSP setup message indicating TCP as a transport protocol to the external device 200 in step 511. The external device 200 responds by sending an RTSP OK message in step 513. After activating a video player application, the mobile terminal 100 sends a video stream through TCP to the external device 200, and the external device 200 displays the received video stream and reports reception status through RTCP to the mobile terminal 100 in step 515. The mobile terminal 100 examines the RTCP report; if no error occurred, the mobile terminal 100 sends a next video stream, and if an error occurred, the mobile terminal 100 resends a corresponding video stream.

When a different application is activated during video stream transmission, the mobile terminal 100 determines whether to conduct transport protocol switching. For example, when an incoming call is received during video playback, the mobile terminal 100 displays an incoming call indication on the display unit. When the user answers the incoming call, the mobile terminal 100 displays a call handling screen. In the event that a usage condition change occurs in this manner, the mobile terminal 100 sends an RTP switching request (RTSP SET_PARAMETER(UDP)) through RTSP to the external device 200 in step 521. The external device 200 responds by sending an RTSP OK message in step 523. After transport protocol switching, the mobile terminal 100 sends call handling screen data through UDP to the external device 200 in step 525. The external device 200 displays received call handling screen data but does not send an RTCP response.

When the call is ended during screen data transmission via UDP and the user reactivates the video player application, the mobile terminal 100 sends an RTP switching request (RTSP SET_PARAMETER(TCP)) through RTSP to the external device 200 in step 531. The external device 200 responds by sending an RTSP OK message in step 533. The mobile terminal 100 sends a video stream through TCP to the external device 200, and the external device 200 displays the received video stream and reports reception status through RTCP to the mobile terminal 100 in step 535.

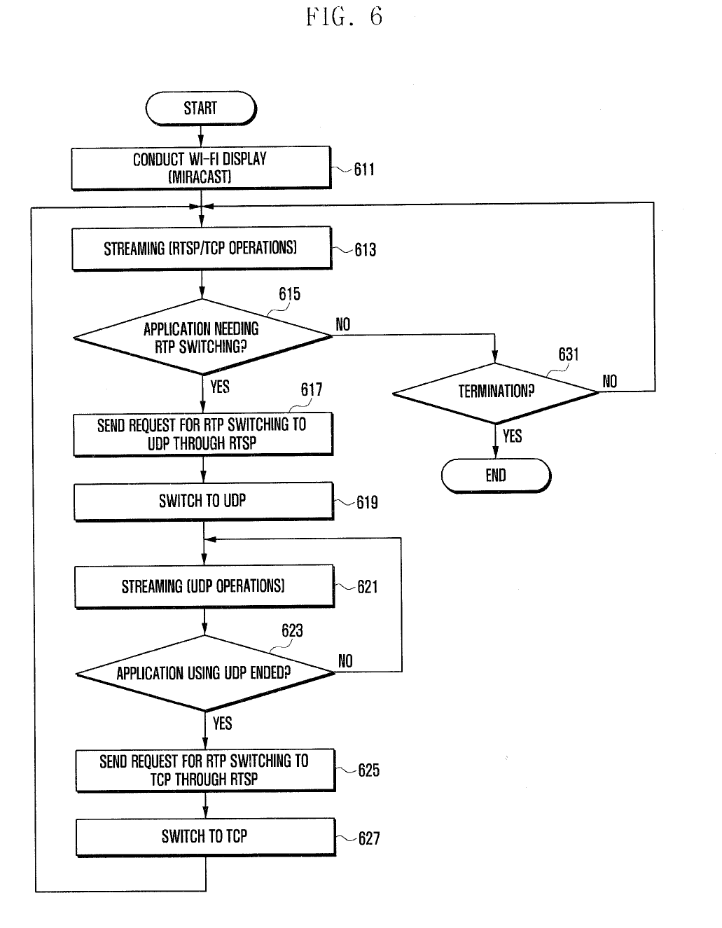

FIG. 6 is a flowchart of a procedure performed by a mobile terminal for transport protocol switching according to an exemplary embodiment of the present invention.

Referring to FIG. 6, for screen sharing, the mobile terminal 100 and the external device 200 initiate Wi-Fi Display (Miracast) based on Wi-Fi Direct communication in step 611. The mobile terminal 100 activates a video player application, and sends a video stream through TCP to the external device 200. The external device 200 displays the received video stream and reports reception status through RTCP to the mobile terminal 100 in step 613. At step 613, the mobile terminal 100 examines the RTCP report; if no error occurred, the mobile terminal 100 sends a next video stream, and if an error occurred, the mobile terminal 100 resends a corresponding video stream.

During video stream transmission via TCP, the control unit 160 determines whether a different application is activated in step 615. When a different application is activated, the mobile terminal 100 sends an RTP switching request (RTSP SET_PARAMETER(UDP)) through RTSP to the external device 200, and waits for a response from the external device 200 in step 617. Upon reception of an RTSP response, the mobile terminal 100 conducts transport protocol switching to UDP in step 619, and streams screen data of the newly activated application through UDP to the external device 200 in step 621. The external device 200 displays screen data received through UDP but does not send an RTCP response.

During screen data transmission via UDP, the mobile terminal 100 checks whether the newly activated application is terminated in step 623. When the newly activated application is terminated and the user reactivates the video player application, the mobile terminal 100 sends an RTP switching request (RTSP SET_PARAMETER(TCP)) through RTSP to the external device 200 in step 625. Upon reception of an RTSP OK message from the external device 200, the mobile terminal 100 conducts transport protocol switching to TCP in step 627, and returns to step 613 and sends a video stream through TCP to the external device 200. The external device 200 displays the received video stream and reports reception status through RTCP to the mobile terminal 100.

When a termination request for Wi-Fi Display is issued during screen sharing in step 631, the mobile terminal 100 ends the procedure of Wi-Fi Display.

As described above, according to an exemplary embodiment of the present invention, TCP may be used as a transport protocol to transmit video streams for screen sharing between the mobile terminal 100 and the external device 200. The video player application may be used to play back, for example, stored moving images, moving images captured by a camera or camcorder, moving images downloaded from an external network such as the Internet, and broadcasts received from a broadcasting station. When a different application is activated during screen sharing through TCP transmission, the mobile terminal 100 suspends TCP transmission and sends screen data of the newly activated application through UDP or Reliable UDP to the external device 200. Reliable UDP is an enhanced version of UDP supporting retransmission, and permits a preset number of retransmissions in response to occurrence of a packet reception error. When the video player application is reactivated after termination of the newly activated application, the mobile terminal 100 sends a request for transport protocol switching to TCP, and sends video streams through TCP after receiving a response from the external device 200.

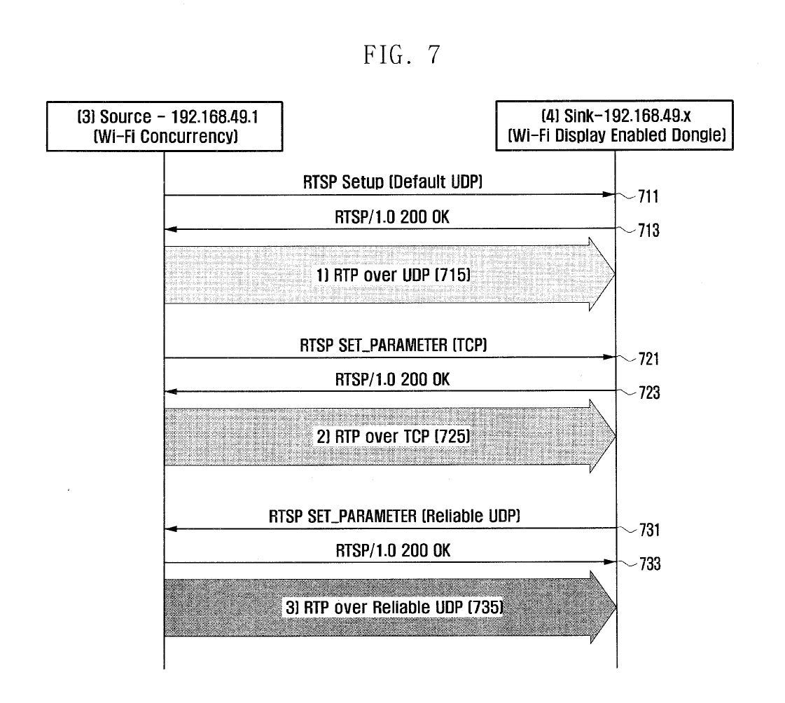

FIG. 7 is a sequence diagram illustrating transport protocol switching while a mobile terminal shares screen data with an external device through Wi-Fi Display, where the mobile terminal and/or the external device perform switching between multiple transport protocols according to analysis of communication conditions in the Wi-Fi Direct domain, according to an exemplary embodiment of the present invention.

Referring to FIG. 7, the mobile terminal 100 sends an RTSP setup message indicating UDP as a default transport protocol to the external device 200 in step 711. An RTSP session between the mobile terminal 100 (source) and the external device 200 (sink) is established using UDP by default. The external device 200 responds by sending an RTSP OK message in step 713. The mobile terminal 100 sends a data stream through UDP to the external device 200 (RTP over UDP), and the external device 200 displays the received data stream in step 715. The external device 200 does not send an RTCP response for the received data stream.

During data transmission and reception, the mobile terminal 100 and/or the external device 200 monitors communication conditions in the Wi-Fi Direct domain. When communication conditions become acceptable, the transport protocol may be switched from UDP to TCP. In this case, the mobile terminal 100 sends an RTP switching request (RTSP SET_PARAMETER(TCP)) through RTSP to the external device 200 in step 721. Step 721 may be performed by the external device 200. The external device 200 responds by sending an RTSP OK message in step 723. The mobile terminal 100 sends a data stream through TCP to the external device 200 (RTP over TCP), and the external device 200 displays the received data stream and reports reception status through RTCP to the mobile terminal 100 in step 725. The mobile terminal 100 examines the RTCP report; if no error occurred, the mobile terminal 100 sends a next data stream, and if an error occurred, the mobile terminal 100 resends a corresponding data stream.

During data transmission and reception via TCP, the mobile terminal 100 and/or the external device 200 monitors communication conditions in the Wi-Fi Direct domain. When communication conditions become worse, the transport protocol may be switched from TCP to UDP (or Reliable UDP). In this case, the external device 200 determines to perform transport protocol switching and sends an RTP switching request (RTSP SET_PARAMETER(UDP)) through RTSP to the mobile terminal 100 in step 731. The mobile terminal 100 responds by sending an RTSP OK message in step 733. The mobile terminal 100 sends a data stream through UDP to the external device 200 in step 735. In steps 731 to 735, Reliable UDP may be used instead of UDP. Reliable UDP is an enhanced version of UDP supporting retransmission and thus is tolerant of packet loss.

As described above, the mobile terminal 100 and/or the external device 200 may perform RTP switching according to communication conditions in the Wi-Fi Direct domain.

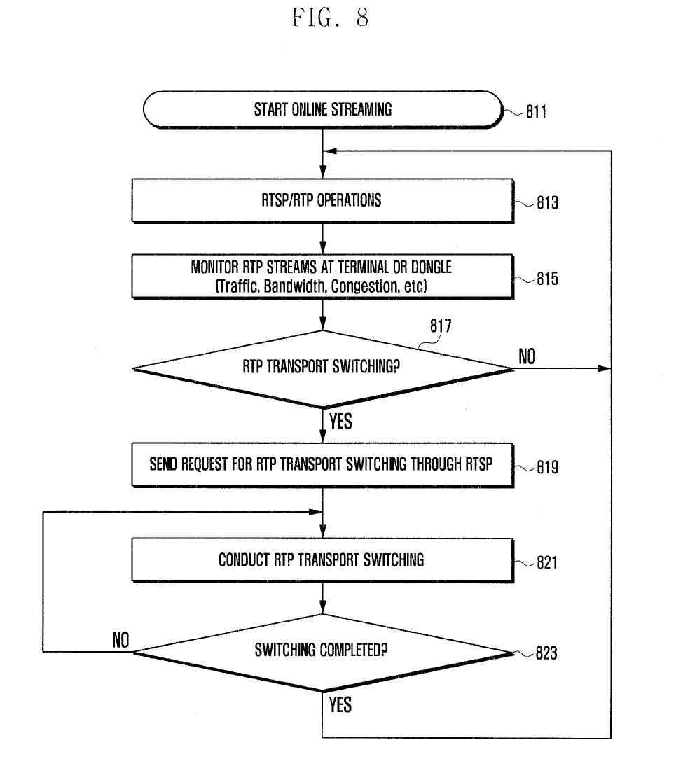

FIG. 8 is a flowchart of a procedure for RTP switching while a mobile terminal sends a screencast to the external device through Wi-Fi Display according to an exemplary embodiment of the present invention. In FIG. 8, the mobile terminal 100 may be a source and the external device 200 may be a sink.

Referring to FIG. 8, after the mobile terminal 100 is connected to the external device 200 for Wi-Fi Display, the mobile terminal 100 initiates stream transmission to the external device 200 in step 811. The mobile terminal 100 and the external device 200 perform RTSP and RTP operations to send and display a data stream in step 813. RTSP is used to create, maintain and terminate an end-to-end session between the mobile terminal 100 and the external device 200. The mobile terminal 100 sends screen data to the external device 200 through RTP (UDP/TCP/SCTP), and the external device 200 displays the screen data. RTP data is transmitted through a transport protocol such as UDP, TCP, or SCTP. Transport protocols such as UDP, TCP, and SCTP may behave differently in terms of latency, error recovery and buffering time. The following description is focused on operation of the mobile terminal 100.

The mobile terminal 100 (or the external device 200) monitors RTP streams in step 815, and determines whether to conduct RTP transport switching in step 817. RTP streams may be monitored in the Wi-Fi Direct domain in terms of parameters related to traffic, bandwidth, congestion (RTT, retransmission and windowing), and end-node characteristics such as TCP/IP capacity. When it is determined to conduct RTP transport switching, RTSP may be used to notify the determination to the other side.

Below, a description is given of how to determine to conduct RTP transport switching by the mobile terminal 100 (or the external device 200) on the basis of the above parameters.

For traffic, when FPS (frames per second) of data streamed by the source exceeds a preset reference value, transport protocol switching to TCP may be determined. When the resolution of data streamed by the source is higher than a preset reference value, transport protocol switching to TCP may be determined. For example, when video of HD class or higher is streamed, TCP may be determined as a transport protocol. When non-video data is streamed by the source, transport protocol switching to UDP may be determined.

For bandwidth, when connected to a band at which Wi-Fi Direct is set up (e.g. 5 GHz), transport protocol switching to TCP may be determined. Transport protocol switching to TCP or UDP may be determined according to error rates at Wi-Fi MAC.

For congestion, it is possible to detect occurrence of congestion between the source and the sink on the basis of the following TCP variables. When occurrence of congestion is detected, rate control may be applied in parallel. When RTT (tcpi_rtt) is greater than or equal to a threshold value, transport protocol switching to UDP may be determined. When the send congestion window (tcpi_snd_cwnd) does not exceed a preset reference value, transport protocol switching to UDP may be determined. When the value “TCP unacked” (tcpi_unacked) exceeds a preset reference value, transport protocol switching to UDP may be determined.

Table 1 below illustrates tcp_info tcpi.

```
TABLE 1
    if (getsockopt(tcp_work_socket, SOL_TCP, TCP_INFO, (void
*)&tcp_info, &tcp_info_length ) == 0 )
    {
    tcp_info.tcpi_last_data_sent
    tcp_info.tcpi_last_data_recv
    tcp_info.tcpi_snd_cwnd
    tcp_info.tcpi_snd_ssthresh
    tcp_info.tcpi_rcv_ssthresh
    tcp_info.tcpi_rtt
    tcp_info.tcpi_rttvar
    tcp_info.tcpi_unacked
    tcp_info.tcpi_sacked
    tcp_info.tcpi_lost
    tcp_info.tcpi_retrans
    tcp_info.tcpi_fackets
    }
```

For TCP/IP capacity, it is possible to determine to conduct RTP transport switching by identifying available transport protocols (such as TCP, UDP, Reliable UDP, and SCTP), and by checking receive/send window variables (such as wmem_max, rmem_max, tcp_rmem, tcp_wmem and initcwnd).

The mobile terminal 100 and/or the external device 200 monitor parameters such as traffic, bandwidth, congestion and TCP/IP capacity in step 815, and determine whether to conduct RTP transport switching according to monitoring results in step 817. Upon determining to conduct RTP transport switching, the mobile terminal 100 (or the external device 200) sends an RTP transport switching request through RTSP to the external device 200 (or the mobile terminal 100) in step 819. The mobile terminal 100 and external device 200 conduct RTP transport switching in step 821. When RTP transport switching is completed in step 823, the mobile terminal 100 returns to step 813 and continues to send RTP streams through a newly switched transport protocol.

As described above, while the mobile terminal 100 and the external device 200 share screen data through Wi-Fi Display, the mobile terminal 100 and/or the external device 200 may autonomously select a transport protocol to be used according to communication conditions. Parameters usable to determine whether to conduct transport protocol switching may include traffic, bandwidth, congestion and TCP/IP capacity. The mobile terminal 100 and the external device 200 may monitor these parameters and adaptively perform RTP transport switching accordingly.

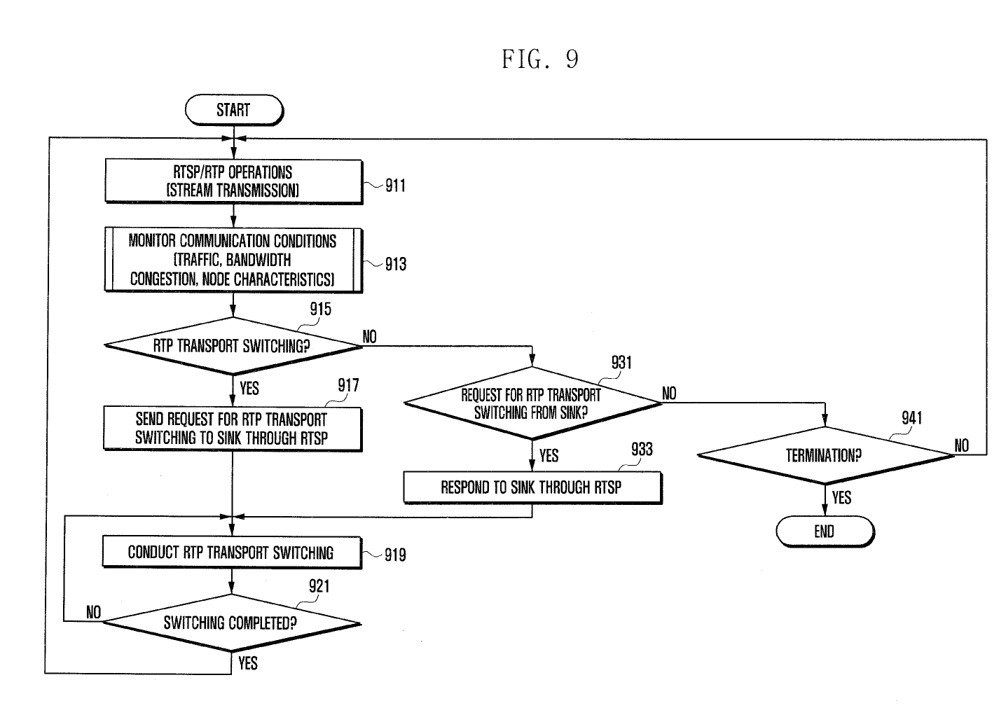

FIG. 9 is a flowchart of a procedure performed by a mobile terminal for RTP switching while the mobile terminal sends a screencast to the external device through Wi-Fi Display. In FIG. 9, the mobile terminal 100 may be a source and the external device 200 may be a sink.

Referring to FIG. 9, after the mobile terminal 100 is connected to the external device 200 for Wi-Fi Display, the mobile terminal 100 initiates stream transmission to the external device 200 in step 911. The mobile terminal 100 and the external device 200 perform RTSP and RTP operations to send and display a data stream. RTSP is used to create, maintain and terminate an end-to-end session, and RTP is used to stream screen data. The external device 200 displays the same screen data as that of the mobile terminal 100.

During RTSP and RTP operations, the mobile terminal 100 monitors RTP streams (communication conditions) in step 913, and determines whether to conduct RTP transport switching according to monitoring results in step 915. RTP streams may be monitored in the Wi-Fi Direct domain in terms of parameters related to traffic, bandwidth, congestion (RTT, retransmission and windowing), and end-node characteristics such as TCP/IP capacity. Upon determining to conduct RTP transport switching, RTSP may be used to notify the determination to the other side. Use of these parameters for determining whether to conduct RTP transport switching is described above in connection with FIG. 8. Upon determining to conduct RTP transport switching, the mobile terminal 100 sends an RTP transport switching request through RTSP to the external device 200 in step 917 and, upon reception of an RTSP response, conducts RTP transport switching in step 919. When RTP transport switching is completed in step 921, the mobile terminal 100 returns to step 911 and continues to send RTP streams through a newly switched transport protocol.

Upon determining not to conduct RTP transport switching at step 915, the mobile terminal 100 determines whether an RTP transport switching request is received through RTSP from the external device 200 in step 931. The external device 200 displaying received streaming data may also monitor RTP streams and send, upon determining to conduct RTP transport switching according to monitoring results, an RTP transport switching request through RTSP to the mobile terminal 100. When an RTP transport switching request is received, the mobile terminal 100 responds by sending an RTSP OK message in step 933, and conducts RTP transport switching in step 919. Parameters (or communication conditions) monitored by the external device 200 may include all or some of parameters monitored by the mobile terminal 100. The external device 200 may not perform RTP monitoring. In this case, steps 931 and 933 may be skipped.

When a termination request for Wi-Fi Display is issued during stream transmission in step 941, the mobile terminal 100 ends the procedure of Wi-Fi Display.

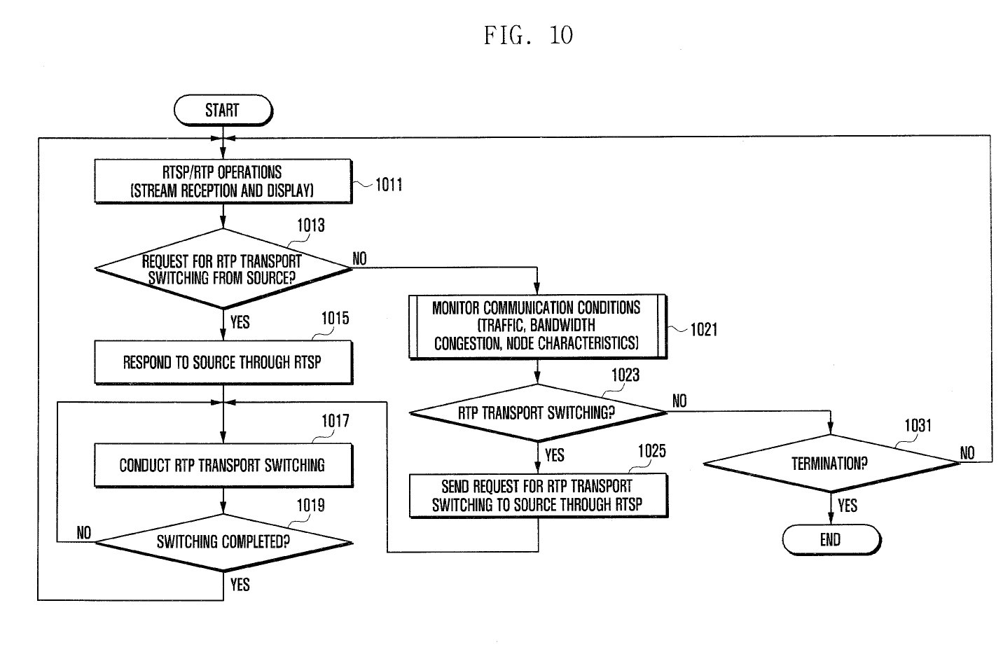

FIG. 10 is a flowchart of a procedure performed by an external device for RTP switching while a mobile terminal sends a screencast to the external device through Wi-Fi Display according to an exemplary embodiment of the present invention. In FIG. 10, the mobile terminal 100 may be a source and the external device 200 may be a sink.

Referring to FIG. 10, the external device 200 connected through Wi-Fi Display to the mobile terminal 100 displays received screen data in step 1011. The external device 200 performs RTSP and RTP operations to receive a data stream from the mobile terminal 100. RTSP is used to create, maintain, and destroy an end-to-end session, and RTP is used to stream screen data. The external device 200 displays the same screen data as that of the mobile terminal 100.

During RTSP and RTP operations, the external device 200 determines whether an RTP transport switching request is received from the mobile terminal 100 through RTSP in step 1013. When an RTP transport switching request is received, the external device 200 responds by sending an RTSP OK message in step 1015, and conducts RTP transport switching with a transport protocol indicated by the request in step 1017. When RTP transport switching is completed in step 1019, the external device 200 returns to step 1011, and continues to receive RTP streams through a newly switched transport protocol and display the same. When the transport protocol is switched to TCP, the external device 200 periodically reports reception status through RTCP to the mobile terminal 100. When the transport protocol is switched to UDP, the external device 200 does not report reception status.

During RTSP and RTP operations, the external device 200 may monitor RTP streams. When an RTP transport switching request is not received in step 1013, the external device 200 monitors RTP streams (communication conditions) in step 1021. Monitoring RTP streams to determine whether to conduct RTP transport switching is described above in connection with FIG. 8. The external device 200 may monitor RTP streams in the same manner as the mobile terminal 100, and parameters (or communication conditions) monitored by the external device 200 may include all or some of parameters monitored by the mobile terminal 100. The external device 200 determines whether to conduct RTP transport switching according to monitoring results in step 1023. Upon determining to conduct RTP transport switching, the external device 200 sends an RTP transport switching request through RTSP to the mobile terminal 100 in step 1025, and conducts RTP transport switching in step 1017. When RTP transport switching is completed in step 1019, the external device 200 returns to step 1011 and continues to receive RTP streams through a newly switched transport protocol.

The external device 200 may not perform RTP monitoring. In this case, steps 1021 to 1025 may be skipped. When a termination request for Wi-Fi Display is issued during stream reception in step 1031, the external device 200 ends the procedure of Wi-Fi Display.

According to exemplary embodiments of the present invention, when a mobile terminal shares screen data with an external device through Wi-Fi Display (Miracast) based on a Wi-Fi Direct connection, it is possible to provide high picture quality and overcome vulnerability to Wi-Fi noise. During screencasting, the mobile terminal can monitor communication conditions such as traffic, bandwidth, congestion and TCP/IP capabilities and adaptively transmit RTP data using one of UDP, TCP, SCTP and the like according to monitoring results. Thereby, it is possible to provide a screencasting feature tolerant of Wi-Fi noise and meeting user expectations. For example, for viewing of high-definition video on the external device, TCP is recommended because picture quality is more important than latency. For game playing on the external device, UDP, Reliable UDP, or SCTP is recommended because low latency is most important.

Certain aspects of the present invention can also be embodied as computer readable code on a non-transitory computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, and optical data storage devices. Also, functional programs, code, and code segments for accomplishing the present invention can be easily construed by programmers skilled in the art to which the present invention pertains.

While the invention has been shown and described with reference to certain exemplary embodiments thereof, it should be understood by those skilled in the art that many variations and modifications of the basic inventive concept described herein will still fall within the spirit and scope of the present invention as defined in the appended claims and their equivalents.

What is claimed is:

1. A method of enabling a mobile terminal to share screen data with an external device through Wi-Fi Direct, the method comprising:
establishing a Real-time Transport Protocol (RTP) session using a first transport protocol by sending a Real Time Streaming Protocol (RTSP) setup message to the external device, and transmitting screen data of a first application as RTP packets to the external device through the first transport protocol;
sending, when a second application is activated, an RTSP request message for RTP transport switching to the external device, and transmitting screen data of the second application as RTP packets to the external device through a second transport protocol; and
sending, when execution of the second application is ended, an RTSP request message for RTP transport switching to the external device, and transmitting screen data of the first application to the external device through the first transport protocol.

2. The method of claim 1, wherein the first application is a video application and the first transport protocol is TCP.

3. The method of claim 2, wherein the second application is an application activated during execution of the first application, and the second transport protocol is User Datagram Protocol (UDP).

4. The method of claim 3, wherein the video application is an application that displays moving images downloaded from an external network.

5. The method of claim 3, wherein the video application is an application that displays stored moving images.

6. The method of claim 3, wherein the video application is an application that displays camera-captured images.

7. A method of enabling a mobile terminal to share screen data with an external device through Wi-Fi Direct, the method comprising:
establishing a Real-time Transport Protocol (RTP) session using a first transport protocol by sending a Real Time Streaming Protocol (RTSP) setup message to the external device, and transmitting screen data to the external device as RTP packets through the first transport protocol;
monitoring RTP packets to determine whether to conduct RTP transport switching;
sending, upon determining to conduct RTP transport switching, an RTSP request message for RTP transport switching to the external device, and transmitting screen data as RTP packets to the external device through a second transport protocol.

8. The method of claim 7, wherein the monitoring of the RTP packets comprises examining at least one of conditions related to traffic, bandwidth, congestion and Transmission Control Protocol/Internet Protocol (TCP/IP) capabilities to determine whether to conduct RTP transport switching.

9. The method of claim 8, further comprising:
conducting RTP transport switching when an RTSP request message for RTP transport switching is received from the external device; and
transmitting screen data as RTP packets through a newly switched transport protocol to the external device.

10. The method of claim 9, wherein the monitoring of the RTP packets comprises examining RTP traffic to determine, when the RTP packets carry non-video data, to conduct transport protocol switching to UDP.

11. The method of claim 10, wherein the monitoring of the RTP packets comprises examining RTP traffic to determine, when the frame rate or resolution of the screen data is greater than a reference value, to conduct transport protocol switching to TCP.

12. The method of claim 9, wherein the monitoring of the RTP packets comprises examining RTP bandwidth to determine, when connected to a band at which Wi-Fi Direct is set up, to conduct transport protocol switching to TCP.

13. The method of claim 9, wherein the monitoring of the RTP packets comprises examining congestion to determine, when a TCP variable has a value greater than or equal to a threshold value, to conduct transport protocol switching to UDP.

14. A mobile terminal supporting screen sharing with an external device, comprising:
a communication unit for transmitting screen data to the external device through Wi-Fi Direct;
a control unit for establishing a Real-time Transport Protocol (RTP) session using a first transport protocol by sending an RTSP setup message to the external device, for transmitting screen data to the external device as RTP packets through the first transport protocol, for sending, when RTP transport switching is needed, an RTSP request message for RTP transport switching to the external device, and for conducting transport protocol switching to a second transport protocol; and
a display unit for displaying screen data under control of the control unit.

15. The mobile terminal of claim 14, wherein the control unit sends, when a second application is activated during execution of a first application, an RTSP request message for RTP transport switching to the external device, and sends screen data of the second application through a newly switched transport protocol to the external device.

16. The mobile terminal of claim 15, wherein the control unit conducts transport protocol switching to TCP when a video application is activated, and conducts transport protocol switching to UDP when a non-video application is activated.

17. The mobile terminal of claim 14, wherein the control unit monitors RTP packets to determine whether to conduct RTP transport switching, sends, upon determining to conduct RTP transport switching, an RTSP request message for RTP transport switching to the external device, and transmits screen data through a newly switched transport protocol to the external device.

18. The mobile terminal of claim 17, wherein the control unit monitors at least one of conditions related to traffic, bandwidth, congestion, and TCP/IP capabilities, and determines to conduct transport protocol switching to TCP or UDP according to monitoring results.

19. The mobile terminal of claim 16, wherein the control unit controls, when transport protocol switching to TCP is conducted, the display unit not to display screen data being sent to the external device.

20. The mobile terminal of claim 18, wherein the control unit controls, when transport protocol switching to TCP is conducted, the display unit not to display screen data being sent to the external device.
